(19) United States
(12) Patent Application Publication
(10) Pub. No.: US 2006/0025521 A1
(43) Pub. Date: Feb. 2, 2006

(54) Polymerizing hydrogels including modifying compounds to comprise low amount of residual monomers and by-products and to optimize material properties

(75) Inventors: Volker Frenz, Mainz-Kostheim (DE); Felix Christian Gorth, Ludwigshafen (DE); Oskar Stephan, Hockenheim (DE); Christian Hubert Weidl, Mannheim (DE); Steven R. Merrigan, West Chester, OH (US); Wolfgang Edgar Huhn, Chieti (IT); Stephen A. Goldman, Citta Sant' Angelo (IT); Martin Beck, Maxdorf (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BASF AKTIENGESELLSCHAFT A German Corporation, Ludwigshafen (DE)

(21) Appl. No.: 10/519,186

(22) PCT Filed: Jun. 20, 2003
(86) PCT No.: PCT/EP03/06514

§ 371 Date: Dec. 21, 2004

Related U.S. Application Data
(60) Provisional application No. 60/392,919, filed on Jul. 1, 2002.
(60) Provisional application No. 60/454,205, filed on Mar. 12, 2003.

(51) Int. Cl. C08G 73/02; C08F 2/16

(52) U.S. Cl. 524/800; 522/71

(57) ABSTRACT

The present invention relates to polymerized hydrogels and processes to make such hydrogels, in particular hydrogel adhesives which are capable of attaching to mammalian skin and can be used in various personal care products, such as waste-management articles, and a variety of functional articles to be worn by a human. The hydrogels described herein are characterized by very low amount of residual starting monomers, impurities, and/or by-products that could be formed during polymerization. Specifically, the hydrogels are made by adding scavengers and/or chain transfer agent prior to polymerization. It has been found, that upon addition of same scavengers the material properties of the polymerized hydrogel differ from the properties of gels polymerized without the scavenger. This is due to the fact, that these specific scavengers act also as chain transfer agents in the radical polymerization. Further studies showed that also chain transfer agents, that are no scanvengers for residual monomer(s), impurities or byproducts influence the material properties of the polymerized hydrogel adhesive.

### FIELD OF THE INVENTION

The present invention relates to polymerized hydrogels and processes to make such hydrogels, in particular hydrogel adhesives which are capable of attaching to mammalian skin and can be used in various personal care products, such as waste-management articles, and a variety of functional articles to be worn by a human. The hydrogels described herein are characterized by very low amount of residual starting monomers, impurities, and/or by-products that could be formed during polymerization. Specifically, the hydrogels are made by adding scavengers and/or chain transfer agent prior to polymerization.

It has been found, that upon addition of same scavengers the material properties of the polymerized hydrogel differ from the properties of gels polymerized without the scavenger. This is due to the fact, that these specific scavengers act also as chain transfer agents in the radical polymerization.

Further studies showed that also chain transfer agents, that are no scavengers for residual monomer(s), impurities or byproducts influence the material properties of the polymerized hydrogel adhesive.

The method of adding chain transfer agents prior to polymerization can be used to easily optimize the material properties of a hydrogel adhesive.

### BACKGROUND OF THE INVENTION

While adhesive materials, e.g. hydrogels, in particular mammalian skin adhesives for use in consumer products such as absorbent articles and waste-management articles have previously been described in EP 1 025 823 and EP 1 025 866 respectively, the disclosure of these adhesive materials has mainly occurred in the context of different medical applications, such as skin electrodes, transdermal drug delivery and wound healing respectively. Certain hydrogel requirements for consumer products produced on a large scale, such as absorbent and human waste-management products, are disclosed in EP 1 025 823 and EP 1 025 866. Herein the need for secure attachment, stability of adhesion in presence of excess moisture, and painless removal are included.

Additionally it is particularly important to delivering the above-mentioned benefits, that the hydrogel used must provide a very good safety profile, especially for large scale production of consumer products.

It has been discovered that complete conversion of the used monomers, especially of acrylic acid and derivatives was impossible when low molecular-weight water-soluble and high-molecular weight polymers and copolymers that are soluble or swell up in water (partly crosslinked) had to be prepared. Residual contents above 0.5 and even 1.0% of free monomers are often found in polymers manufactured on an industrial scale.

Since it has been impossible up to now to carry out polymerization without leaving residual monomers, attempts have been made to remove the residuals. This can be achieved either by eliminating the residual monomers or by converting them into safe derivatives.

In U.S. Pat. No. 4,132,844 a method is mentioned for directly reducing the amount of free monomers in an aqueous polymer gel by heating said polymer at a high temperature. In Japanese Patents Nos. 53/51289 and 50/136382, residual monomer content has been reduced by extraction with suitable solvents.

U.S. Pat. Nos. 2,960,486, 3,755,280, and 4,929,717 describe the treatment of a polymer gel based on acrylic acid and/or acrylamide which was made in a conventional manner, with different compounds. The treated polymer gel is then subsequently and systematically dried at an elevated temperature after this treatment before any residual monomer content analysis was carried out.

Unfortunately not only the level of starting unreacted monomers, but also the level of impurities and by-products that could arise from the polymerization step such as acrolein, acrylonitrile or acrylamide, has to be controlled and kept within specifically defined target levels in the resulting hydrogel composition.

None of the above-cited cases were concerned in reducing impurities and/or by-products that could be produced during the polymerization step of starting monomers.

The present invention provides a process for making polymerized hydrogels with very low amount of residual starting monomers, impurities and/or any by-products that could be produced during the polymerization step and/or adjusted properties. This polymerization being conducted from within a reaction medium comprising from 10-90 wt % water, from 10-60 wt % of starting monomers and from 10-80 wt % of a polyol.

The process described in the present invention consists in two successive steps. The first step is a treatment of the polymerizable premix solution with chain transfer agents and/or compounds that react with residual monomers, Impurities and by-products that could be formed during the polymerization step. The second step is the polymerization of the so treated monomer solution leading to an extremely low content of residual monomers and impurities respectively and/or adjusted properties as tan δ₂₅.

It is known that when polyols, e.g. glycerol and the like, are present in polymerized hydrogel made by UV initiation, the level of acrolein must be controlled in the finished composition, and be kept under well-defined target levels. Indeed, contact with acrolein is preferably avoided or should be minimized.

It has also been found that by controlling the pH of the monomer pre-mix solution, the level of acrolein formed during the polymerization reaction is reduced. Furthermore, it has been described that by carefully controlling the UV-radiation during the photopolymerization reaction, it is possible to reduce the formation of acrolein via photodecomposition of free-radical reactions involving glycerol.

It is one purpose of the present invention to provide a method for making polymerized hydrogel with very low level of residual monomers and or other impurities. It is especially useful to reduce the level of compounds that carry carbonylic groups and α,β-unsaturated carbonylic functionalities. The process as claimed, comprises a step consisting in treating monomer premix solutions directly before polymerization, to thereby reduce the concentration of acrolein below long-term safety levels. The present invention is also efficient for reducing the levels of other impurities or by-products including acrylonitrile, acrylamide and residual monomers respectively.

While U.S. Pat. No. 5,606,094 describes a process for scavenging acrolein from a gaseous or liquid mixture containing acrolein in acrylonitrile with sodium bisulfite followed by separation of the reaction products, the process described in the present invention provides a method for incorporating the impurity scavenger before the polymerization step. Therefore the mentioned side products are reduced immediately in the time of their formation. In addition to that residual monomers are reduced by the reaction with surplus of the scavenger compound which can be e.g. sodium bisulfite or any hetero nucleophile.

Another purpose of the present invention is to optimize the material properties of the hydrogel adhesive by adding chain transfer agents prior to the polymerization.

### SUMMARY OF THE INVENTION

In one embodiment, the present invention relates to a process for making polymerized hydrogels, in particular hydrogel adhesives, comprising 10-90 wt % water and 10-60 wt % of a cross-linked hydrophilic polymer. The hydrophilic polymer is made by polymerizing of at least one starting monomer type, and contains 580 wt %, preferably 10-80 wt %, most preferably 30-80 wt % of at least one polyol.

The process described in the present invention consists in two successive steps. The first one consists in mixing said starting monomer(s) within a reaction medium comprising from 10-90 wt % water, from 10-60 wt % of said starting monomer(s) and from 10-80 wt % of at least one polyol, to thereby form a polymerizable monomer solution. To this solution is added a modifying compound pure or in solution and optionally mixed well carefully avoiding the polymerization reaction to take place. In addition an early reaction of the polymerizable monomers with the scavenger compound has to be avoided. The modifying compound can be one chemical entity or a mixture of chemical entities with the same or different effects on the hydrogel. The modifying compound is selected from the group consisting of scavenger compound, chain transfer agent and compound which is a scavenger compound and chain transfer agent.

The second step consists in polymerizing the reaction mixture formed in the first step, to form an hydrogel material. While the polymerization reaction takes place, the scavenger compound immediately reacts with residual monomer(s), impurity(s) and/or with any by-products produced by said polymerization reaction, to thereby reduce the concentration of said residual starting monomer(s), impurity(s) and/or said by-product(s) within said hydrogel.

In a preferred embodiment, the present invention relates to a process allowing to obtaining polymerized hydrogel, in particular adhesive, wherein the polymerization is carried out at least partly by UV irradiation.

The pH of the hydrogel ranges from pH 3.5 to 7, preferably 4 to 6.5, more preferably 4.5 to 6.

In another embodiment, the present invention relates to polymerized hydrogel, in particular adhesive, comprising 10-90 wt % water, 10-60 wt % of cross-linked hydrophilic polymer made from starting monomer(s), and 10-80 wt % of at least one polyol, such hydrogel being prepared by polymerizing said starting monomer(s) in the presence of said water and polyol(s), wherein such hydrogels contain less than 100 ppb, preferably less than 50 ppb, and most preferably less than 20 ppb of a,b-unsaturated carbonyl by-product(s) derived from said polyol(s) during polymerization, and wherein the level of residual starting monomer(s) is below 200 ppm, preferably below 100 ppm, more preferably below 50 ppm, even more preferably below 20 ppm, and most preferably below 10 ppm.

In still another embodiment, the present invention relates to polymerized hydrogel, in particular adhesive, comprising 10-90 wt % water, 10-60 wt % of cross-linked hydrophilic polymer made from starting monomer(s), and 10-80 wt % of at least one polyol, such hydrogel being prepared by polymerizing said starting monomer(s) in the presence of said water and polyol(s), wherein such hydrogels comprise more than 20 ppb, preferably more than 50 ppb, more preferably more than 100 ppb, even more preferably more than 500 ppb, and most preferably more than 1000 ppb of nucleophilic addition product(s) of the α,β-unsaturated carbonyl by-product(s) derived from said polyol(s) during polymerization.

In a further embodiment, the present invention relates to polymerized hydrogel, in particular adhesive, comprising 10-90 wt % water, 10-60 wt % of cross-linked hydrophilic polymer made from starting monomer(s), and 10-80 wt % of at least one polyol, such hydrogel being prepared by polymerizing said starting monomer(s) in the presence of said water and polyol(s), wherein such hydrogels are characterized by having a tan δ₂₅ above 1.

### DETAILED DESCRIPTION

The present invention relates to polymerized hydrogels and processes to make such hydrogels, in particular hydrogel adhesives, which are capable of attaching to mammalian skin.

In a first embodiment, the present invention relates to a process for making a hydrogel comprising 10-90 wt % water, 10-60 wt % of cross-linked hydrophilic polymer made from at least one starting monomer type, and 10-80 wt % of at least one polyol. This process comprises a first step consisting in preparing said monomer(s) solution from 10-90 wt % water, from 10-60 wt % of said starting monomer(s) and from 5-80 wt %, preferably 10-80 wt %, most preferably 30-80 wt % of said polyol(s), and adding a modifying compound to and optionally mixing well in the monomer solution prior to polymerization of the so formed mixture. A part of the amount of the modifying compound can also be added after the polymerization.

In the process of the present invention, the compound which reacts with the starting monomers, impurities, and/or by-products mentioned below and/or the chain transfer agent is preferably added directly to the monomer premix solution in a stirring vessel, a tube or a static mixer and the like. The compound can be added as a pure substance or as mixture of substances or in solution, preferably in aqueous solution and also preferably the quantity of added solution is sufficiently low relative to the amount of the monomer premix solution such that it can be rapidly mixed in the reaction mixture. Alternatively the reaction mixture can be stored by low temperature, e.g. 10° C. or can be stabilized by known polymerization inhibitors.

In a second step the so formed reaction mixture is polymerized to thereby form a hydrogel. In preparing hydrogels in accordance with the present invention, the ingredients will usually be mixed to provide a reaction mixture in the form of an initial pre-gel aqueous based liquid formulation, in this case treated with the modifying compound, which is then converted into a gel by a free radical polymerization reaction. This may be achieved for example using conventional thermal initiators, redox initiators and/or photoinitiators or by ionizing radiation. Such free-radical polymerization initiators are well known in the art and can be present in quantities up to 5% by weight, preferably from 0.02% to 2%, more preferably from 0.02% to 0.4%. Photoinitiation is a preferred method and will usually be applied by subjecting the pre-gel reaction mixture containing an appropriate photoinitiation agent to UV light after it has been spread or coated as a layer on silicone-coated release paper or other solid or porous substrate.

For use in forming the homopolymer or co-polymer component of the polymerized hydrogel, suitable monomers or co-monomers can be acidic, neutral, basic, or zwitterionic. Among acidic monomers, suitable strong-acid types include those selected from the group of olefinically unsaturated aliphatic or aromatic sulfonic acids such as 3-sulfopropyl (meth) acrylate, 2-sulfoethyl (meth) acrylate, vinylsulfonic acid, styrene sulfonic acid, allyl sulfonic acid, vinyl toluene sulfonic acid, methacrylic sulfonic acid and the like and the respective salts. Particularly preferred strong-acid type monomer is 2-acrylamido-2-methylpropanesulfonic acid and its salts. Among acidic monomers, suitable weak-acid types include those selected from the group of olefinically unsaturated carboxylic acids and carboxylic acid anhydrides such as acrylic acid, methacrylic acid, maleic acid, itaconic acid, crotonic acid, ethacrylic acid, citroconic acid, fumaric acid and the like and the respective salts. Particularly preferred weak-acid type monomer is acrylic acid and its salts.

Examples of neutral monomers include N,N-dimethylacrylamide, acrylamide, N-isopropyl acrylamide, hydroxyethyl (meth)acrylate, alkyl (meth)acrylates, N-vinyl pyrrolidone and the like. Examples of cationic monomers include N,N-dimethylaminoethyl (meth)acrylate, N,N-dimethylaminoethyl (meth)acrylamide and the respective quaternary salts and the like. Most preferably, the hydrogel compositions of the invention are based upon acrylic acid monomer and its salts.

The cross-linking between polymer chains creates a 3-dimensional matrix for the polymer, also referred to as gel form or hydrogel. Physical cross-linking refers to polymers having crosslinks that are not chemical covalent bonds but are of a physical nature such that for example there are areas in the 3 dimensional matrix having high crystallinity or areas having a high glass transition temperature or areas having hydrophobic interactions. Chemical cross linking refers to polymers which are linked by covalent chemical bonds, The polymer can be chemically cross linked by radiation techniques such as UV, E beam, gamma or micro-wave radiation or by co-polymerizing the monomers with a di/polyfunctional crosslinker via the use e.g., of UV, thermal and/or redox polymerization initiators. The polymer can also be ionically crosslinked.

Suitable polyfunctional monomer crosslinkers include polyethyleneoxide di(meth)acrylates with varying PEG molecular weights, IRR280 (a PEG diacrylate available from UCB Chemical), trimethylolpropane ethyoxylate tri(methacrylate with varying ethyleneoxide molecular weights, IRR210 (an alkoxylated triacrylate available from UCB Chemicals), trimethylolpropane tri(meth)acrylate, divinylbenzene, pentaerythritol triallyl ether, triallylamine, N,N-methylene-bis-acrylamide and others polyfunctional monomer crosslinkers known to the art. Preferred monomer crosslinkers include the polyfunctional diacrylates and triacrylates.

Chemical crosslinking can also be effected after polymerization by use of polyfunctional reagents capable of reacting with polymer functional groups such as ethyleneglycol diglycidyl ether, polyols such as glycerol, and other polyfunctional reagents known to the art.

Crosslinking can also be effected all or in part by ionic crosslinking wherein groups of opposite charge interact via ionic interactions. Suitable ionic crosslinking agents include those known to the art including polyvalent cations such as Al³⁺ and Ca²⁺, di/polyamines, di/poly-quaternary ammonium compounds, including polymeric polyamines and quaternary ammonium compounds known to the art.

The hydrogel compositions described herein can comprise a humectant, or mixture of humectants (also referred as a plastisizer), which is preferably a liquid at room temperature. The humectant is selected such that the monomer and polymer may be solubilized or dispersed within. For embodiments wherein irradiation crosslinking is to be carried out, the humectant is desirably irradiation crosslinking compatible such that it does not significantly inhibit the irradiation crosslinking process of the polymer. The components of the humectant mixture are preferably hydrophilic and miscible with water.

Suitable humectants include alcohols, polyhydric alcohols such as glycerol and sorbitol, and glycols and ether glycols such as mono- or diethers of polyalkylene glycol, mono- or diester polyalkylene glycols, polyethylene glycols, glycolates, glycerol, sorbitan esters, esters of citric and tartaric acid, imidazoline derived amphoteric surfactants. Particularly preferred are polyhydric alcohols such as glycerol and sorbitol, polyethylene glycol, and mixtures thereof. Glycerol is especially preferred. The humectant comprises 5-80 wt % of the hydrogel.

Other common additives known in the art such as polymerization inhibitors, chain transfer agents, salts, surfactants, soluble or dispersible polymers, buffers, preservatives, antioxidants, pigments, mineral fillers, and the like and mixtures thereof may also be comprised within the adhesive composition in quantities up to 10% by weight each respectively.

The term polyols refer to alcohol compounds having more than one hydroxyl group. Polyols include polyhydric alcohols and are also called polyalcohols. As it was mentioned previously, polyols are well known in the art as common additives for making hydrogels. Therefore, a method for reducing by-products formed from these polyols during polymerization, is particularly useful.

In a preferred embodiment of the present invention, is provided a process where the polymerization is conducted at least partly by photoinitiation polymerization. Photoinitiation will usually be applied by subjecting the pre-gel reaction mixture of monomer(s) containing an appropriate photoinitiation agent to UV light after it has been spread, coated, or extruded as a layer on silicone-coated release paper or other solid or porous substrate. The incident UV intensity, typically at a wavelength in the range from about 240 to about 400 nm overlaps to at least some degree with the UV absorption band of the photoinitiator and is of sufficient intensity and exposure duration (e.g., 120-36000 mW/cm²) to complete the polymerization of the reaction mixture.

Such free radical photoinitiation agents or photoinitiators are well known in the art and can be present in quantities up to 5% by weight, preferably less than 1%, more preferably less than 0.5%, and most preferably less than 0.4%. Such photoinitiators include type á-hydroxy-ketones and benzilidimethyl-ketals. Suitable photoinitiators include dimethylbenzylphenone (available under the trade name or Irgacure 651 from Ciba Speciality Chemicals). 2-hydroxy-2-methyl-propiophenone (available under the trade name Darocur 1173 from Ciba Speciality Chemicals), 1-hydroxycyclohexyl-phenyl ketone (available under the trade name Irgacure 184 from Ciba Speciality Chemicals), diethoxyacetophenone, and 4-(2-hydroxyethoxy)phenyl-(2-hydroxy-2-methylpropyl) ketone (available under the trade name of Irgacure 2959 from Ciba Speciality Chemicals). Darocure 1173, Irgacure 2959 and Irgacure 184 are preferred photoinitiators. Irgacure 2959 and Irgacure 184 are particularly preferred. In the hydrogel compositions described in the present invention, Irgacure 2959 is the most preferred photoinitiator. Combinations of photoinitiators can also be used. In addition, polymerization can be carried out by using thermal initiator(s) and/or redox initiator(s) well known to the art or one or more of these initiators in combination with the aforementioned photoinitiators. Suitable thermal initiators include potassium persulfate and VA044 (available from Wako). Suitable redox initiators include the combination of hydrogen peroxide and ascorbic acid and sodium persulfate and ascorbic acid.

It has been shown that during the photopolymerization process, when glycerol is used as the polyol, it can produce acrolein as a by-product. A method suitable for measuring the level of acrolein in a polymerized adhesive hydrogel is described in the Test Methods section.

Without being bound by theory, it is believed that acrolein (2-propenal) can be formed by acid-catalyzed or base-catalyzed reactions of glycerol and glycerol esters with free radicals generated during photopolymerization, wherein the concentration of free radicals are especially high. It is believed that by controlling the pH within the limits described hereinafter, the amount of acrolein generated during photo-polymerization as a result of these acid or base catalyzed reactions can be diminished.

Also, without being bound by theory, it is believed that the analogous reaction(s) can occur with other polyols yielding α,β-unsaturated carbonyl by-products such as ene-als, ene-ones and the like.

It has been described, in a co-pendant application, that by controlling the pH of the monomer pre-mix solution in the range of 3.5 to 7, preferably 4-6.5, more preferably 4.5-6; that the level of acrolein formed during the polymerization reaction is reduced. This is especially important to control the level of acrolein in the finished hydrogel.

Furthermore, it has been found that the wavelength of the UV-radiation should be carefully controlled during the photopolymerization reaction, to obtain optimum results on reduction of acrolein. It is preferable to minimize the relative percentage of UV irradiation reaching the monomer solution and hydrogel with wavelengths below 280 nm, preferably below 300 nm, more preferably below 320 m, most preferably below 335 nm. This can be achieved by the use of a UV light source that has inherently low output in these wavelength ranges or by interposing one or more high-pass UV-filters between the UV light source and the monomer solution and hydrogel.

Examples of high-pass UV filters that can be used for this purpose include the Boro-float UV Filters (e.g., T320) available from Bedampfungs-technik. Other examples include the high-pass UV filters made by Schott Glass Werke (e.g. WG-280, WG-295, WG-305, WG-320, and WG-325). It is preferred that the integrated UV intensity in units of W/cm2 in the aforementioned wavelength regions by reduced to less than 10%, preferably less than 7%, more preferably less than 4%, most preferably less than 1% of the integrated UV intensity in the entire region (i.e., 200400 nm).

Without being bound by theory, it is also believed that reducing the UV irradiation in the aforementioned wavelength ranges also reduces the formation of acrolein via photodecomposition or fee-radical reactions involving glycerol.

Nevertheless, the preferred overall strategy is to choose polymerization conditions that reduce the concentration of starting monomers and their impurities to very-low levels, even if it generates an increased concentration of by-products.

In the case where the polymerization is conducted at least partly by UV irradiation, this step may depend on two process parameters, the incident UV peak intensity (in units of W/cm²) and/or the total UV energy (in units of J/cm²). It is preferred to use UV irradiation which leads to a total UVA energy ranging from 0.1-30 J/cm², preferably from 0.1-25 J/cm², more preferably from 1-20 J/cm². These conditions are those preferred at driving down the starting monomer(s).

The process as claimed in the present invention comprises a chemical pre-polymerization treatment of the monomer premix solution, with a compound that reacts with residual monomers, impurities and/or by-products of the polymerization reaction.

Residual monomers are the unreacted monomers of the hydrophilic crosslinked polymer of the current invention.

Impurities include conjugated olefins such as acrylonitrile, acrylamide, acrolein, acrylates, t-butylacrylamide, other substituted acrylamides and the like that are introduced into the hydrogel premix in minor amounts along with the main ingredients. Some conjugated olefins can be found as impurities and also be formed as by-products of the polymerization reaction.

The chemical treatment refers to any chemical reactions known in the art that may be applied to a compound. These reactions include, but are not limited to, substitution, addition, elimination, cyclisation, pericyclic reaction, oxidation, and reduction. Addition reactions are particularly preferred in the process described in the present invention.

The by-products of the polymerization reaction refer to all products that are produced from any ingredients of the reaction medium including impurities, whatever the polymerization conditions applied are. The by-products produced from said polyol(s) are of particular concern in the present invention.

These by-products may comprise α,β-unsaturated carbonyls such as acrolein, acrylamides, acrylates, and the like. For example, as it was previously mentioned glycerol can produce acrolein as a decomposition product during the photopolymerization step. It is also known that acrylamido-2-methane propanesulfonic acid (AMPS) can decompose to generate acrylamide. Acrolein is the by-product of particular concern in the present invention. But other by-products that could derive from common additives used for making hydrogels, are within the scope of the invention.

The scavenger compound that reacts with residual monomers, impurities, and/or by-products can be in particular, a nucleophile, an oxidizing agent, a reducing agent, a conjugated diene or mixtures of these. For the process described in the present invention, it is particularly preferred that the compound be a nucleophile.

Suitable nucleophiles include the whole range of hetero nucleophiles wherein hetero nucleophiles are nucleophiles with a polarizable heteroatom like N, S, O or P. Preferred nucleophiles are ammonia, ammonium salts of mineral and carboxylic acids (e.g. chlorides, bromides, sulfates, phosphates, formiates, acetates, acrylates, propionates, tartrates and the like), arylamines (wherein aryl preferably means monocyclic or bicyclic aromatic rings which are optionally substituted by one, two or more substituents. The substituents are independently of each other preferably selected from the group consisting of C₁-C₆-alkyl, OH, C₁-C₆-alkoxy, nitro, halogen etc. Examples are e.g. aniline, methylaniline, benzylaniline, xylidine and the like), heteroaromates (wherein heteroaromates preferably means monocyclic or bicyclic aromatic rings with one, two, or more heteroatoms like N, O, S, which are optionally substituted by one, two or more substituents. The substituents are independently of each other preferably selected from the group consisting of C₁-C₆-alkyl, OH, C₁-C₆-alkoxy, nitro, halogen etc. Preferred are N-heteroaromates. Examples ate e.g. pyridine, imidazole, methylimidazole etc.), alkylamines and/or their mineral or carboxylic salts (alkylamines means preferably mono-, di- or trialkylamines with C1-C₆ alkyl chains wherein two alkyl chains can form together with the N a ring of 5 or 6 members. Examples are e.g., piperidine, piperizine, mono-, di- and tri-butylamine, dimethylamine, diethylamin, dipropaneamine, triethylamine, etc.), multifunctional amines (which are preferably mono-, di- or triamines of alkyl or aryl amines. Examples are e.g. hexamethylendiamine, ethylendiamine, propanediamine diethylentriamine) polyamines (e.g. polyvinylamine), hydroxylamine, hydrazine, aminoguanidine, alkali sulfites, ammonium sulfites, alkali or ammonium hydrogen sulfites, alkali-, or ammonia-metabisulfites or -bisulfites, hydrogen halide, bromosuccinimide, pyridinium bromide, bromine, or thiols. Aminoguanidine, bisulfite and metabisulfite are particularly preferred in the present invention.

Oxidizing agents may include permanganate, bichromate, chromate, selenium dioxide, osmium tetroxide, sodium periodate, or ozone, peroxides (sodium persulfate, dibenzoylperoxide etc.) or hydroperoxides (e.g. benzoylhydroperoxide, hydrogenperoxide).

Reducing agents may include metal hydrides, sodium hypochlorite, metals and their salts of mineral and carboxylic acids (e.g. chlorides, bromides, sulfates, phosphates, formiates, acetates, acrylates, propionates, tartrates and the like), or Grignard reagents, metal chelates (e.g. iron, titanium, cer, cupper, cobald, manganese chelates of EDTA class of compoundes and derivatives, preferably BASF trilon®) brands), alkali and ammonia sulfites, methane sulfine acids and their salts, e.g. sodium formaldehyde sulfoxylate, saccharides (e.g. ascorbic acid, glucose, frutose and the like).

Dienes may include cyclopentadiene, hexachlorocyclopentadiene, isoprene, 2-methoxybutadiene, and the like.

When the compound is a nucleophile, it is particularly preferred that it reacts with the double bond(s) of the starting monomers, impurities and/or the by-products by an addition reaction.

In the process of the present invention, the scavenger compound which reacts with said residual starting monomer(s), impurity(s) and/or by-products is preferably present in amounts of less than 30000 ppm, preferably less than 10000 ppm, more preferably less than 5000 ppm or less than 2000 ppm, most preferably less than 1000 ppm, with respect to the hydrogel. Normally the minimum amount of scavenger compound is more than 200 ppm, preferably more than 100 ppm, more preferably more than 50 ppm, most preferably less than 10 ppm.

The resulting hydrogel contains less than 200 ppm, preferably less than 100 ppm, more preferably less than 50 ppm, and even more preferably less than 20 ppm, most preferably less than 10 ppm of all residual monomer(s). Additionally, it is preferred that the resulting hydrogel contain less than 1000 ppb, preferably less than 500 ppb, more preferably less than 100 ppb, even more preferably less than 50 ppb, and most preferably less than 20 ppb of by-product(s) derived from said polyol(s) during polymerization. Furthermore, and if applicable, it is preferred that the polymerized hydrogel contain less than 100 ppb, preferably less than 50 ppb, more preferably less than 25 ppb and most preferably less than 10 ppb of acrylonitrile and/or acrylamide.

In another embodiment, the present invention relates to polymerized hydrogel, in particular adhesive, comprising 10-90 wt % water, 10-60 wt % of cross-linked hydrophilic polymer made from starting monomer(s), and 10-80 wt % of at least one polyol, such hydrogel being prepared by polymerizing said starting monomer(s) in the presence of said water and polyol(s), wherein such hydrogels contain less than 100 ppb, preferably less than 50 ppb, and most preferably less than 20 ppb of α,β-unsaturated carbonyl by-product(s), derived from said polyol(s) during polymerization, and wherein the level of residual starting monomer(s) is below 200 ppm, preferably below 100 ppm, more preferably below 50 ppm, and even more preferably below 20 ppm, and most preferably below 10 ppm.

In yet another embodiment, the present invention relates to polymerized hydrogel, in particular adhesive, comprising 10-90 wt % water, 10-60 wt % of cross-linked hydrophilic polymer made from starting monomer(s), and 10-80 wt % of at least one polyol, such hydrogel being prepared by polymerizing said starting monomer(s) in the presence of said water and polyol(s), wherein such hydrogels contain less than 100 ppb, preferably less than 50 ppb, and most preferably less than 20 ppb of acrolein and wherein the level of residual starting monomer(s) is below 200 ppm, preferably below 100 ppm, more preferably below 50 ppm, and even more preferably below 20 ppm, and most preferably below 10 ppm.

In still another embodiment, the present invention relates to polymerized hydrogel, in particular adhesive; comprising 10-90 wt % water, 10-60 wt % of cross-linked hydrophilic polymer made from starting monomer(s), and 10-80 wt % of at least one polyol, such hydrogel being prepared by polymerizing said starting monomer(s) in the presence of said water and polyol(s), wherein such hydrogels comprise more than 20 ppb, preferably more than 50 ppb, more preferably more than 100 ppb, even more preferably more than 500 ppb, and most preferably more than 1000 ppb of nucleophilic addition product(s) of the a,b-unsaturated carbonyl by-product(s) derived from said polyol(s) during polymerization. The aforementioned nucleophilic addition product(s) refer to all products resulting directly or indirectly from said addition reaction between a suitable nucleophile(s) and α,β-unsaturated carbonyl by-product(s) derived from said polyol(s) during polymerization. The resulting possibilities are innumerable but when bisulfite is selected to be said suitable nucleophile, and acrolein is selected as the α,β-unsaturated carbonyl, the addition products can comprise sodium-3-propanal sulfonate, 1-hydroxy-2-propene-1-sulfonate, 1-hydroxy-1.3-propane disulfonate.

Hydrogel adhesives polymerized in the presence of scavengers that are also chain transfer agents, showed different material properties than hydrogel adhesives polymerized without these scavengers. Further studies revealed that also chain transfer agents that are no scavengers influence the material properties of the polymerized hydrogel adhesive. Chain transfer agents that are scavengers are however preferred, due to their benefit of residual monomer and impurity reduction.

The most important material properties are the rheological behavior and the peel force. They are described in detail in EP 1025823 A1 and EP 1025866 A1.

Typically the material properties are changed by varying the solid content of the monomer premix and/or the amount of crosslinker. This can not easily be done, after the premix has been prepared. Adding chain transfer agents is an easy and elegant way to optimize material properties without changing premix composition. This opens a way to a more flexible hydrogel production. It also saves costs if the premix does not have to be discarded, but the material-properties can be changed by adding chain transfer agents.

In order to provide adhesives for secure initial and prolonged attachment and easy/painless removal the relation between the elastic modulus and the viscous modulus as well as their dynamic behavior is also of importance.

The adhesive has an elastic modulus at a temperature of 25° C. (770 Fahrenheit) abbreviated G′₂₅ and a viscous modulus at a temperatur of 25° C. (770 Fahrenheit) of G″₂₅.

The adhesive according to the present invention preferably satisfies the following conditions;
G′₂₅ (1 rad/sec) is in the range 200 Pa to 30000 Pa.
   preferably 500 Pa to 20000 Pa, most
   preferably 1000 Pa to 10000 Pa.
G″25 (1 rad/sec) is in the range 100 Pa to 30000 Pa.
   preferably 100 Pa to 10000 Pa, most
   preferably 300 Pa to 5000 Pa.
      and the ratio of G″₂₅ (1 rad/sec)/G′₂₅ (1 rad/sec) (tan δ₂₅) is in the range of 0.03 to 3. Preferred are tan δ₂₅-values between 0.2 and 0.9, more preferred between 0.4 and 0.8. Also preferred are hydrogels with a tan δ₂₅-values above 1, more preferred between 1.01 and 2, most preferred 1.02 and 1.5.

So far only values of tan δ₂₅ that are smaller than 1 have been described. By the use of chain transfer agents it is now possible to obtain hydrogels with a ratio greater than 1. For some applications it can be advantageous to have these values greater than 1.

The hydrogels described herein preferably have a 90° peel force on dry skin of between 0.3 to 5 N/cm, more preferably 1.5 to 3 N/cm. Peel force can also be measured at 180° on Polyethylene terephthalate (PET). The hydrogels herein preferably have a peel force on PET of between 0.3 to 5.0 N/cm, preferably between 0.5 to 3.0 N/cm and more preferably between 0.8 to 2.0 N/cm. The methods for measuring peel force on skin and PET are described hereinafter in the test methods section.

Suitable chain transfer agents that are also scavengers include, but are not limited to nucleophiles as stated above. Especially preferred is sodium bisulfite.

Suitable chain transfer agents that are no scavengers include, but are not limited to organic acids such as formic acid, acetic acid, ascorbic acid and the like, thiols, such as 2-mercapto ethanol, armomatic compounds such as toluene, chlorobenzene, aniline, benzonitrile, anthracene and the like, halogenated compounds such as dichloromethane, chloroethanol and the like, polyalcohols and sugars such as glycerol, sorbitol, glucose, arabinose and the like, alcohols such as iso-propanol or n-propanol.

While particular embodiments of the present invention have been illustrated and described, it would be obvious to those skilled in the art that various other changes- and modifications can be made without departing from the spirit and scope of the invention. It is therefore intended to cover in the appended claims all such changes and modifications that are within the scope of this invention.

Test Methods

1. pH of Monomer Solutions

The pH of a monomer solution can be measured using methods well known to the art. For example, an lonlabph/ion level 2P meter can be used equipped with a SenTix 41 electrode (available from Wissenschaftlich Technische Werkstaetten).

2. Residual NaAMPS and Acrylic Acid in Polymerized Hydrogels

Sample Preparation: 100 ml of 0.9% w/v saline solution are added to 1.0000 g hydrogel and the mixture is shaken in a thermostatic bath for a minimum of 16 hours at 40° C. An aliquot of the exctract is collected into a syringe and transfered it through a 0.20 μm hydrophilic filter into a HPLC autosampler vial.

Analysis: Reversed-phase HPLC/DAD, −50il of the hydrogel filtrate (as above) is injected directly into the HPLC, for example an Agilent Series 1100 equipped with an Agilent Series 1100 solvent delivery module, Agilent Series 1100 auto injector, Agilent Series 1100 photo diode array detector and an Agilent Zorbax SB AQ 4, 6×150 mm 5 lm analytic-column and an Agilent Zorbax SB AQ 4, 6×12.5 mm as guard-coloumn. The mobile phase comprises 96% of eluent A (H2O, containing 0,867 mmol/l Phosphoric acid) and 4% of eluent B (Acetonitrile). The flow rate is 1, 2 ml/min. The analytic temperature is 30° C. A photo diode array channel 200 nm (bandwidth 5 nm) is used for detection, the UV Spectra across 190-300 nm can be applied for peak purity assessment. The level of analyte is quantified using standard procedures well known to the art and reported as micrograms analyte per gram of hydrogel (ppm). The quantitative detection limit of NaAMPS is below 5 microgram analyte per gram hydrogel (ppm). The quantitative detection limit of Acrylic Acid is below 3 microgram analyte per gram hydrogel (ppm), based on a signal/noise ratio of 10.

3. Residual Acrylonitrile and Acrolein in Polymerized Hydrogels

Sample preparation:

The protective foil is removed from the “Hydrogel-Sample”. Then c. 5 g are weighed into a wide-necked bottle. To the sample 500 ml of NaCl-solution (0.9% w/w) are added. This preparation is stored at 40° C. for c. 24 hours. During normal working time the bottle is shaken vigorously every hour. After 24 hours the bottle is allowed to cool down to room temperature, then the liquid phase is separated.

Final determination:

Principle:

Acrolein and acrylonitrile are determined via purge & trap GC-MS analysis. For purge & trap a suitable commercial autosampler can be used. The autosampler is connected to a capillary gas chromatograph coupled to a quadrupole mass spectrometer.

Off-line purge & trap can be carried out as well, then the adsorption tube has to be analysed further on a GC-MS system equipped with a thermodesorption unit.

Principle information about the analytical technique is given in EPA methods 5030B and 8260B.

For quantification an external standard procedure is recommended. Standard addition method can cause systematic errors, if residual bisulfite is present in the extract, which may react with the spiked standards. In such a case too high values are evaluated.

A portion of 5 ml (2 ml for higher concentrated or foaming sample extracts) of the separated aquatic extract is used for purge & trap GC-MS analysis.

Possible measurement parameters are given below:

For purge & trap the autosampler PTA-3000 (supplied by IMT) was used:

| | | | | | |
|---|---|---|---|---|---|
| sample temperature: | 40° | C. | | | |
| purge time: | 20 | min | purge flow: | 20 | ml He/min |
| valve temperature: | 80° | C. | transfer line: | 200° | C. |
| trap cooling | −120° | C. | water trap | −15° | C. |
| temperature: | | | temperature: | | |
| trap desorption temp.: | 200° | C. | desorption | 10 | min |
| | | | time: | | |

Chromatographic conditions:

fused silica column:

RTX-VMS (supplied by Restec) length: 60 m, internal diameter 0.32 mm, film thickness 01.8 μm
Temp.-Progr.: 7 min isothermal at 40° C.
   40° C.-80° C. with 7 K/min
   80° C.-220° C. with 14 K/min
   13 min isothermal at 220° C.
Injector temperature: 200° C. Transfer line temperature: 220° C.
carrier gas: helium 0.6 bar
Quadrupol MS system (e.g. MD 800 supplied by Thermo Quest)
source temperature: 220° C.:
ionisation: El⁺
selected ion monitoring: m/z 52 and 53 for acrylonitrile
   (m/z 53 used for evaluation)
   m/z 55 and 56 for acrolein
   (m/z 56 used for evaluation)

Calibration is carried out by preparing standard solutions in a NaCl-solution (0.9% w/w) at the interesting concentration level. The standard solution is analysed by purge & trap GC-MS under the same conditions like the Hydrogel extracts.

4. Rheology

The rheology of hydrogels is measured at 25° C. using a HAAKE RHEOSTRESS 1 oscillatory rheometer or the equivalent. A sample of thickness of approximately 1 mm and diameter of 20 mm is placed between two insulated Parallel Plates of 20 mm diameter, controlled at a temperature of approximately 25° C. using a Peltier system or equivalent. A Dynamic Frequency Sweep is performed on the hydrogel in either stress or strain mode at an applied strain within the linear elastic response of the hydrogel (e.g., up to a strain of about 10%), with measurements at discrete frequency values between 47, 75 Hz (300 rad/sec) and 0, 143 Hz (0, 8992 rad/sec). Results are quoted as G′, G″ and tan delta at frequency values of 1.0 and 100 rad/sec. The hydrogel is aged at least 24 hours before measurement. The average of at least three determinations are reported.

5. Peel Force on Dry Skin

The peel force to remove hydrogel from dry skin is measured using a suitable tensile tester, for example an Instron Model 6021, equipped with a 10N load cell and an anvil rigid plate such as the Instron accessory model A50L2R-100. Samples are cut into strips of width 25.4 mm and length between about 10 and 20 cm. A non-stretchable film of length longer than the hydrogel is applied to the reverse side of the hydrogel sample (e.g. the substrate side) using double sided adhesive. A suitable film is 23μ thick PET, available from Effegidi S.p.A., 43052, Colomo, Italy. For samples with release paper, the release paper is removed prior to applying the hydrogel to the forearm and then rolling it into place using a compression weight roller to prevent air entrapment between hydrogel and skin. The roller is 13 cm in diameter, 4.5 cm wide and has a mass of 5 kg. It is covered in rubber of 0.5 mm thickness. The free end of the backing film is attached to the upper clamp of the tensile tester and the arm is placed below. The sample is peeled from the skin at an angle of 90 degrees and a rate of 1000 mm/min. The average peel value obtained during peeling of the whole sample is quoted as the peel value in N/cm. The average of triplicate measurements is reported.

6. Peel Force on PET

Peel force to remove hydrogel from poly(ethylene teraphthalate) (PET) film is measured using a suitable tensile tester, for example a Zwick Z1.0/THIS, equipped with a 50N load cell and a pneumatic grip like Zwick Model: 8195.01.00 and attachment for a rigid lower plate, e.g. steel, oriented along the direction of cross-head movement. Freshly produced hydrogel is stored in a closed aluminium bag or similar for at least 12 to 24 hours at room temperature before measuring. A defect free sample of at least 10 cm in length Is cut from the hydrogel sample. A piece of double sided adhesive, for example type Duplofol 020DIVB+L from Lohmann GmbH Postoffice box 1454 56504 Neuwied, at least 130 mm long and 25.4 mm wide is stuck to the front side of the lower plate. The hydrogel is punched out with a Zwick mechanical cutting press like Zwick model 7104 using a cutting tool 25,4 mm wide and 25, 4 cm long. The second linder is removed from the tape and it is stuck on the back side of the hydrogel sample. A strip of standard PET of 23/thickness and no corona treatment, is cut to about 300 mm×28 mm. Suitable material would include “Cavilen-Forex” from Effegidi S.p.A., Via Pro-vinciale per Sacca 55, I-43052 Colomo, Italy. The release liner is removed from the hydrogel and the bottom end fixed to the rigid plate by regular tape. The standard substrate is then applied onto the body adhesive using a hand roller once forward and once backward at a speed of 1000 to 5000 mm/min. The roller is 13 cm in diameter, 4, 5 cm wide and has a mass of 5 kg. It is covered in rubber of 0,5 mm thickness. The measurement is preferably performed within 10 minutes of application of the substrate.

The free end of the standard substrate is doubled back at an angle of 180 degrees and the rigid plate is clamped in the lower clamp of the tensile tester. The free end of the standard substrate is fixed in the upper clamp of the tensile tester. The peel test is performed at a speed of 1000 mm/min. The initial 20 mm of peel is disregarded and the average force over the remaining length is quoted as the peel force in N/cm. The average of triplicate measurements is reported.

### EXAMPLES

General Description of Gel Preparation

a) Laboratory Samples Containing Na Amps

Approximately 22.4 parts of 50 wt % Na-AMPS solution, approx. 16.6 parts of acrylic acid and approx. 10.4 parts of deionized water are mixed together. To this solution approximately 5.5 parts 50 wt % NaOH is added dropwise with constant stirring, while maintaining the temperature below 30° C. with an ice bath. After addition of the NaOH approx. 44.8 parts of glycerol are added together with approx. 0.1 parts crosslinker (i.e IRR 210) and approx. 0.2 parts of photoinitiator (e.g Darocure 1173 or Irgacure 2959) and nudeophiles X (e.g. sodium bisulfite or aminoguanidine). The nucleophiles can be added as pure compounds or as solutions). The procedure is carried out in brown glassware which is covered with a brown watch glass to protect the reaction mixture from light. After stirring for about 15 to 30 minutes the reaction mixture is poured on a teflon coated plate to give a 1 mm thick layer. The reaction mixture is than irradiated with a 2000 W Hönle UV lamp at 100 mW/cm². Typical irradiation times range between 60 s to 180 s. The gels are then covered with regular photocopy paper and peeled off the plate. The other side of the gel is covered with a release liner (e.g. siliconized paper).

b) Laboratory Samples Non-Containing Na-AMPS

Approximately 57.8 parts of 50 wt % Na-Acrylate (70% neutralized) solution, approx. 41.9 parts of glycerol are added together with approx. 0.1 to 0.3 parts crosslinker (i.e. IRR 210) and approx. 0.2 parts of photoinitiator (e.g. Darocure 1173 or Irgacure 2959) and nucleophile or chain transfer agent X (e.g. 2-Mercapto ethanol, formic acid or sodium bisulfide). The compound X can be added as pure compound or as solution. The procedure is carried out in brown glassware which is covered with a brown watch glass to protect the reaction mixture from light. After stirring for about 15 to 30 minutes the reaction mixture is poured on to a teflon coated plate to give a 1 mm thick layer. The reaction mixture is than irradiated with a 2000 W Hönle UV lamp at 100 mW/cm². Typical irradiation times range between 60 s to 180 s. The gels are then covered with regular photocopy paper and peeled off the plate. The other side of the gel is covered with a release liner (e.g. siliconized paper).

c) Pilot Line Samples

The composition of the monomer mix is unchanged compared to the laboratory samples (see a)). The addition of the nucleophiles X can be batchwise into the stirred tank reactor or be online (e.g. static mixer). The monomer mixture, including the nucleophiles, is extruded onto a substrate (e.g a nonwoven webbing) at a basis weight of approximately 1.0 kilograms per square meter. Polymerization is carried out by irradiating with UV light using 1 to 7 2000 W Hönle UV lamps or 1 to 12 high power IST UV lamps or a combination of both. The lamps can be equipped with glass filters that cut wavelength below 320 nm. By this process the monomer solution is converted into an adhesive hydrogel. After passing the UV lamps this adhesive hydrogel is covered with a release liner (e.g siliconized paper or oriented polypropylene (OPP) foil), trimmed to the required width and wound up onto rolls.

d) Preparation of Nucleophile Solutions

The solutions are prepared by dissolving the nucleophiles in deionized water.

Experimental Results

| | Acrylic acid | AMPS | Acrolein |
|---|---|---|---|
| X | (ppm) | (ppm) | (ppm) |
| Aminoguanidine 0 ppm (laboratory) | NA | NA | 1.135 |
| Aminoguanidine | NA | NA | 0.435 |
| 1000 ppm (laboratory) | | | |
| NaHSO₃ 0 ppm (pilot line) | 210 | 441 | 0.6 |
| NaHSO₃ 500 ppm (pilot line) | 234 | 383 | 0.07 |
| NaHSO₃ 1000 ppm (pilot line) | 215 | 423 | <0.05 |

The following table shows that the scavenger sodium bisulfite also acts as a chain transfer agent and influences the material properties.

| X | Acrylic acid | AMPS | Acrolein | G′₂₅ [Pa] | G″₂₅ [Pa] | | Peel on PET |
|---|---|---|---|---|---|---|---|
| (ppm) | (ppm) | (ppm) | (ppm) | (1 rad/sec) | (1 rad/sec) | tan δ₂₅ | (N/in) |
| NaHSO₃ | 210 | 441 | 0.6 | 3374 | 1780 | 0.53 | 0.94 |
| 0 ppm | | | | | | | |
| NaHSO₃ | 234 | 383 | 0.07 | 2592 | 1606 | 0.62 | 1.60 |
| 500 ppm | | | | | | | |
| NaHSO₃ | 215 | 423 | <0.05 | 1654 | 1261 | 0.76 | 2.64 |
| 1000 ppm | | | | | | | |
| NaHSO₃ | 89 | 26 | not | 1394 | 1469 | 1.05 | 2.50 |
| 2000 ppm | | | detected | | | | |

In the following table the influence of a chain transfer agent that is no nucleophile (e.g. formic acid) on a laboratory sample containing no NaAMPS is shown.

| X | Acrylic acid | G′₂₅ [Pa] | G″₂₅ [Pa] | tan | Peel on PET |
|---|---|---|---|---|---|
| (ppm) | (ppm) | (1 rad/sec) | (1 rad/sec) | δ₂₅ | (N/in) |
| Formic Acid | 1188 | 10927 | 4791 | 0.44 | 0.55 |
| 3200 ppm | | | | | |
| Formic Acid | 1077 | 8975 | 4191 | 0.47 | 0.47 |
| 6400 ppm | | | | | |
| Formic Acid | 870 | 7013 | 3679 | 0.52 | 0.56 |
| 12800 ppm | | | | | |

Postinitiation by Pretreatment with Redox Couples

Residual monomers, impurities and by-products can also be reduced by adding a mixture of the compounds X,Y,Z to the monomer mix prior to UV-polymerization. The compounds X,Y are forming redox couples which are able to initiate polymerizations. These redox couples include e.g. Fe²⁺/OH₂O₂, Fe²⁺/NaPS. Iron complexing agents Z (e.g. BASF Trilon brands) can be added in addition to the redox couples to (partially) complex the iron ions.

For the following table the acrylic acid was extracted for analysis at the same day the samples were prepared:

| | | | | Acrylic acid |
|---|---|---|---|---|
| X | Y | Z | Extracted after | (ppm) |
| Fe²⁺ | H₂O₂ | Trilon D | 0 days | 811 |
| (0 ppm) | (0 ppm) | (0 ppm) | | |
| Fe²⁺ | H₂O₂ | Trilon D | 0 days | 586 |
| (50 ppm) | (3000 ppm) | (0 ppm) | | |
| Fe²⁺ | H₂O₂ | Trilon D | 0 days | 481 |
| (50 ppm) | (3000 ppm) | (12.5 ppm) | | |
| Fe²⁺ | H₂O₂ | Trilon D | 0 days | 359 |
| (50 ppm) | (3000 ppm) | (25 ppm) | | |
| Fe²⁺ | H₂O₂ | Trilon D | 0 days | 239 |
| (50 ppm) | (3000 ppm) | (37.5 ppm) | | |

The residual monomer reducing effect continues with time:

| | | | | | Acrylic acid |
|---|---|---|---|---|---|
| X | Y | Z | Extracted after | | (ppm) |
| Fe²⁺ | H₂O₂ | Trilon D | 0 | days | 481 |
| (50 ppm) | (3000 ppm) | (12.5 ppm) | | | |
| Fe²⁺ | H₂O₂ | Trilon D | 4 | days | 403 |
| (50 ppm) | (3000 ppm) | (12.5 ppm) | | | |
| Fe²⁺ | H₂O₂ | Trilon D | 7 | days | 269 |
| (50 ppm) | (3000 ppm) | (12.5 ppm) | | | |
| Fe²⁺ | H₂O₂ | Trilon D | 14 | days | 14 |
| (50 ppm) | (3000 ppm) | (12.5 ppm) | | | |
| Fe²⁺ | H₂O₂ | Trilon D | 0 | days | 239 |
| (50 ppm) | (3000 ppm) | (37.5 ppm) | | | |
| Fe²⁺ | H₂O₂ | Trilon D | 4 | days | 24 |
| (50 ppm) | (3000 ppm) | (37.5 ppm) | | | |
| Fe²⁺ | H₂O₂ | Trilon D | 7 | days | 10 |
| (50 ppm) | (3000 ppm) | (37.5 ppm) | | | |

1. A process for making a hydrogel comprising 10-90 wt % water, 10-60 wt % of a cross-linked hydrophilic polymer made from at least one starting monomer type, and 10-80 wt % of at least one polyol, wherein said process comprises the steps of
a) preparing a starting monomer solution from 10-90 wt % water, 10-60 wt % of said starting monomer, and 10-80 wt % of said polyol, and adding a modifying compound to said monomer solution prior to polymerization of the so formed mixture, then
b) polymerizing said monomer within a reaction medium comprising 10-90 wt % water, 10-60 wt % of said starting monomer, and 10-80 wt % of said polyol, in the presence of the modifying compound to form a hydrogel,
wherein the modifying compound is selected from the group consisting of a thiol, a sulfite, a metabisulfite, and a bisulfite.

2. The process of claim 1 wherein the modifying compound is added directly to the monomer solution before the polymerization in a stirring vessel, a tube, or a static mixer.

3. The process of claim 1 wherein in addition to the modifying compound, a scavenger compound is added to the monomer solution.

4. The process of claim 1 wherein in addition to the modifying compound, a chain transfer agent is added to the monomer solution.

5. The process of claim 1 wherein in addition to the modifying compound, a scavenger compound and a chain transfer agent are added to the monomer solution.

6. The process of claim 1 wherein a residual monomer concentration in the hydrogel below 10000 ppm.

7. The process of claim 1 wherein the polymerization of said starting monomer is conducted at a pH 3.5 to 7.

8. The process of claim 1 wherein said hydrogel comprises 20-70 wt % water.

9. A The process of claim 1 wherein adding the modifying compound comprises adding to said monomer solution a nucleophile which reacts with said residual starting monomer, impurity, by-product, or mixture thereof by an addition reaction.

10. The process according to claim 9 wherein said by-product comprises an α,β-unsaturated carbonyl produced from said polyol.

11. The process of claim 10 wherein said polyol comprises glycerol.

12. The process of claim 11 wherein said by-product comprises acrolein.

13. The process of claim 9 wherein the bisulfite is present in an amount of less than 30000 ppm with respect to the hydrogel product.

14. The process of claim 1 wherein polymerization of said starting monomer is conducted at least partly by UV irradiation.

15. The process of claim 1 wherein said reaction medium comprises a photoinitiator.

16. The process of claim 15 wherein said photoinitiator is selected from the group consisting of 2-hydroxy-2-methyl-propiophenone, 4-(2-hydroxyethoxy)-phenyl-(2-hydroxy-2-methylpropyl) ketone, Irgacure 500, and 1-hydroxycyclohexyl phenyl ketone.

17. The process of claim 16 wherein said photoinitiator is used in said monomer solution at a concentration less than 5 wt %.

18. The process of claim 1 wherein the polymerization is conducted by UV curing, and an integrated UV intensity at wavelengths less than 280 nm is less than 10% of the total integrated UV intensity with wavelengths less than 400 nm.

19. The process of claim 18 wherein said polymerization is carried out under a total UVA energy ranging from 0.1-30 J/cm².

20. The process of claim 1 wherein said starting monomer comprises acrylic acid.

21. The process of claim 1 wherein said hydrogel is adhesive.

22. The process of claim 1 wherein said hydrogel has a tan δ₂₅ between 0.03 and 3.

23. A hydrogel prepared by the process of claim 1.

24. A hydrogel comprising 10-90 wt % water, 10-60 wt % of a cross-linked hydrophilic polymer made from starting monomer(s), and 10-80 wt % of a at least one polyol, said hydrogel prepared by polymerizing said starting monomer(s) in the presence of said water and polyol(s), wherein said hydrogel contains less than 100 ppb of α,β-unsaturated carbonyl by-product(s) derived from said polyol(s) during polymerization.

25. The hydrogel of claim 25 where said α,β-unsaturated carbonyl by-product comprises acrolein.

26. (canceled)

27. The process of claim 1 wherein the residual monomer concentration is below 500 ppm.

28. The process of claim 1 wherein the residual monomer concentration is below 10 ppm.

29. The process of claim 1 wherein the polymerization of said starting monomers is conducted at pH 4.5 to 6.

30. The process of claim 9 wherein the bisulfite is present in an amount of less than 10,000 ppm with respect to the hydrogel product.

31. The process of claim 9 wherein the bisulfite is present in an amount of less than 1,000 ppm with respect to the hydrogel product.

32. The process of claim 16 wherein the photoinitiator is used is said monomer solvate at a concentration less than 1 wt %.

33. The process of claim 16 wherein the photoinitiator is used is said monomer solvate at a concentration less than 0.4 wt %.

34. The method of claim 18 wherein the integrated UV intensity at wavelengths less than 320 nm is less than 1% of the total integrated UV intensity with wavelengths less than 400 nm.

35. The hydrogel of claim 24 wherein said hydrogel contains less than 20 ppb of α,β-unsaturated carbonyl by-product(s).
